(19) United States
(12) Patent Application Publication
(10) Pub. No.: US 2022/0241891 A1
(43) Pub. Date: Aug. 4, 2022

(54) ARTIFICIAL INTELLIGENCE-BASED ROBOTIZED SMART LASER ABLATING SYSTEMS FOR MULTI-DIMENSIONAL OBJECTS

(71) Applicant: 6684327 Canada Inc., Gatineau (CA)

(72) Inventors: Steeve LAVOIE, Gatineau (CA); Mohamed ABOUSEIF, Gatineau (CA); Beshari JAMAL, Gatineau (CA)

(21) Appl. No.: 17/431,314

(22) PCT Filed: Feb. 14, 2020
(86) PCT No.: PCT/CA2020/050196

§ 371 Date: Aug. 16, 2021

Related U.S. Application Data
(60) Provisional application No. 62/805,718, filed on Feb. 14, 2019.

(51) Int. Cl. B23K 26/03; G06N 5/02; B23K 26/12; B23K 26/16; B23K 26/36; B23K 26/0622; G01N 21/71

(52) U.S. Cl. CPC B23K 26/03; G06N 5/022; B23K 26/127; B23K 2103/50; B23K 26/36; B23K 26/0622; G01N 21/718; B23K 26/16

(57) ABSTRACT

A system for ablating a predetermined area of a substrate material, the system comprising: a processor; a computer readable medium comprising at least one first set of program instructions associated with the ablating protocol stored thereon, the ablating protocol comprising calibration parameters; a laser head associated with a laser power controller for generating a laser pulse having a wavelength, pulse width and output level based on the calibration parameters, wherein the laser pulse is transmitted to the laser head having an optical assembly to shape and focus a beam of the laser pulse on the substrate material; wherein the laser pulse impinges the substrate material and the layer material and emits a plasma plume and sound; sensor to capture light emitted by the plasma plume and sound emitted during the ablation event; and detector means to capture emitted light of the plasma plume associated with the ablation event.

### FIELD OF INVENTION

The present disclosure relates to laser ablation, more particularly it relates to employing a laser to remove dirt or an undesired layer from a surface of a substrate material.

### BACKGROUND

In the nuclear industry various methods are used for oxidized surface decontamination, and removal of a deposited layer with radioactive materials from metallic surfaces or building materials, such as cement, concrete and brick, which are extremely porous. Removing contaminants off cement, concrete and brick may be especially challenging since the surfaces may include cracks and pores in which the contaminants may reside. Cleaning up chemical-contaminated structures can be difficult, costly, and time-consuming. For one thing, most preferred methods employ other chemicals, like bleach solutions, which can be corrosive and aggressive to many types of surfaces. As an example, several methods of decontamination implement concrete scabbling and oxide layer removal, such as, water jetting, mechanical scabbling, steam cleaning, chemical cleaning and wet abrasive cleaning. However, most of these methods produce a substantial amount of secondary waste and require complex external control and deployment systems.

Other current decontamination methods include hands-on cleaning e.g. wet wipes, brushes, scrub tools, cleaners), ultrasonic cleaning methods, high-pressure steam cleaning e.g. a mixture of cleaning solutions, water and high-pressure steam, and dry ice blasting techniques (3 mm dry ice pellets and high-pressure air). One of the challenges with all the above decontamination methods is that there is a wide range of radioactive waste (including liquid and solid wastes) as well the technics range in labour costs.

Another method for removing undesired layers off materials is laser ablation, a process of removing surface material by using a high intensity laser beam. When a focused laser beam with a particular power intensity irradiates a solid surface of the substrate material the absorption of the laser beam on the solid surface atomizes the surface material and/or substrate material.

Several laser ablating systems have been proposed to remove a variety of layers such as paint, rust, nuclear contamination, from different substrate materials, however, these systems available on the market have basic functionalities and can only be operated by properly trained professionals, such as engineers or technicians. Accordingly, these prior art systems require substantial human intervention, since all the decision-making associated with the ablation process must be performed by the trained professionals. Another drawback of existing systems is the challenge of manually maintaining the focus of the laser on the material being cleaned, and maintaining the laser head at a critical distance from the substrate material. Other issues include: the need to determine laser parameters for a particular material, often via trial and error; the inability by the existing systems to determine the coating characteristics on the surface material and the underlying substrate material to be kept intact; the inability to self-inspect the cleaning performed by the laser after each pass, or after a cleaning session for quality control purposes; and the inability to decide when to stop cleaning; the inability to calculate the laser damage threshold of the material to be cleaned; the inability to recognize shape of the object to be cleaned; the inability to accumulate knowledge and learn from previous cleaning sessions; the inability to change laser settings on the fly; and the lack of self-learning by the system to optimize the ablation process or make predictions about the ablation process. These factors, among others, have contributed to the rather slow adoption of this technology in the market.

It is an object of the present disclosure to mitigate or obviate at least one of the above-mentioned disadvantages.

### SUMMARY OF THE INVENTION

In one of its aspects, there is provided a laser ablating system for ablating a a substrate material with a layer material to be removed, the system comprising:

a processor,

a computer readable medium comprising at least one first set of program instructions executable by the processor to determine calibration parameters for ablating the substrate material;

a laser head associated with a laser power controller for generating a laser pulse based on the calibration parameters, wherein the laser pulse impinges the substrate material and the layer material, and emits a plasma plume and sound during an ablation event;

an optical fiber to transmit the laser pulse to the laser head having an optical assembly to shape and focus a beam of the laser pulse on the substrate material;

at least one sensor to capture light emitted by the plasma plume and sound emitted during the ablation event;

at least one second set of program instructions executable by the processor to determine spectrum peaks and levels from the emitted light and emitted sound emitted and output spectral data and acoustic data; and

a cognitive element configured to process the spectral data and acoustic data over time and dynamically modify the calibration parameters at least in part responsive to the spectral data and sensor data, to meet desired quality requirements in the ablation event.

In another of its aspects, there is provided a method of laser ablating an area of a substrate material with a layer material to be removed, the method comprising the steps of:

(a) selecting an ablating protocol based on the characteristics of the substrate material and the characteristics of the layer material;

(b) executing, with a processor, at least one first set of program instructions associated with the ablating protocol stored in a computer readable medium to determine calibration parameters for a laser power controller and a laser head;

(c) based on the calibration parameters, generating a laser pulse having a wavelength, pulse width and output level;

(d) transmitting, via an optical fiber, the laser pulse to the laser head having an optical assembly to shape and focus a beam of the laser pulse on the substrate material;

(e) initiating an ablation event by moving the laser head in any one of a x, y and z direction, to cause the laser pulse to impinge the substrate material and the layer material and emit a plasma plume and sound;

(f) capturing at least one of emitted light of the plasma plume and acoustic signals and images, and measuring the temperature associated with the ablation event; receiving, at the processor, the captured at least one of emitted light of the plasma plume, acoustic signals, temperature measurements, and images; and executing, with the processor, at least one second set of program instructions stored in the computer readable medium to determine spectral components of the plasma plume; and

(g) determining, based on at least one of the determined spectral components of the plasma plume, the images, the temperature measurements, and the acoustic signals whether the desired quality requirements for ablating the substrate material are met; when the desired quality requirements are met then continuing the ablation event until the area has been ablated; else dynamically modifying the calibration parameters without user intervention, and proceeding to step (c).

In another of its aspects, there is provided a program storage device readable by a computer, tangibly embodying a program of instructions executable by at least one processor to perform the steps in a method, comprising:

(a) selecting an ablating protocol for ablating an area of a substrate material with a layer material to be removed, the ablating protocol based on the characteristics of the substrate material and the characteristics of the layer material;

(b) executing, with the at least one processor, at least one first set of program instructions associated with the ablating protocol stored in a computer readable medium to determine calibration parameters for a laser power controller and a laser head;

(c) based on the calibration parameters, generating a laser pulse having a wavelength, pulse width and output level;

(d) transmitting, via an optical fiber, the laser pulse to the laser head having an optical assembly to shape and focus a beam of the laser pulse on the substrate material;

(e) initiating an ablation event by moving the laser head in any one of a x, y and z direction, to cause the laser pulse to impinge the substrate material and the layer material and emit a plasma plume and sound;

(f) capturing at least one of emitted light of the plasma plume and acoustic signals and images, and measuring the temperature associated with the ablation event; receiving, at the at least one processor, the captured at least one of emitted light of the plasma plume, acoustic signals, temperature measurements, and images; and executing, with the at least one processor, at least one second set of program instructions stored in the computer readable medium to determine spectral components of the plasma plume; and

(g) determining, based on at least one of the determined spectral components of the plasma plume, the images, the temperature measurements, and the acoustic signals whether desired quality requirements for ablating the substrate material are met; when the desired quality requirements are met then continuing the ablation event until the area has been ablated; else dynamically modifying the calibration parameters without user intervention, and proceeding to step (c).

In another of its aspects, there is provided at least one sensor for detecting the characteristics of the generated laser-induced breakdown spectra of a substrate material, and controlling the output power of the laser power system, such that the settings of the laser system are caused to adapt to match the surface requirements for better quality assurance.

Advantageously, the robotized smart laser ablating system employs artificial intelligence, and minimizes human intervention and decision-making by users; and also reduces errors prevalent in prior art laser ablating systems, especially when cleaning complex structures. The robotized smart laser ablating system is capable of maintaining the focus of the laser beam on the material being cleaned, and maintaining the laser critical distance from the laser head to the material. Furthermore, the substance on the surface material to be removed and the material to be kept intact are determined automatically, including the laser damage threshold of the material to be cleaned. The cleaning process is inspected at predefined intervals, or after each laser pass to determine that the quality requirements are met, and also determine when to end the cleaning process once the cleaning objectives and desired quality have been achieved. In addition, the shape and the orientation of the object to be cleaned are recognized and the robotic positioning system sends commands to the laser head to maneuver about the object to effect the cleaning. The robotized smart laser ablating system also comprises a cognitive element capable of self-learning using knowledge gained from previous cleaning sessions, and can thereby optimize the ablation process or make predictions about the ablation process; and can also change laser settings on the fly in order to adapt to the dynamic conditions associated with the ablation event.

### BRIEF DESCRIPTION OF THE DRAWINGS

Several exemplary embodiments of the present disclosure will now be described, by way of example only, with reference to the appended drawings in which:

FIG. 1 shows a robotized laser cleaning system, in one exemplary embodiment;

FIG. 2a shows a laser head;

FIG. 2b shows a laser head, in another exemplary implementation;

FIG. 3 shows a laser ablating graphical user interface;

FIG. 4 shows a high-level flow diagram illustrating exemplary process steps for cleaning a substrate material;

FIG. 5 shows a high-level flow diagram illustrating exemplary process steps for cleaning an unknown substrate material; and

FIG. 6 shows an exemplary computing system.

### DETAILED DESCRIPTION OF EXEMPLARY EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Like reference numerals are used to designate like parts in the accompanying drawings.

The detailed description provided below in connection with the appended drawings is intended as a description of the present examples and is not intended to represent the only forms in which the present example may be constructed or used. However, the same or equivalent functions and sequences may be accomplished by different examples.

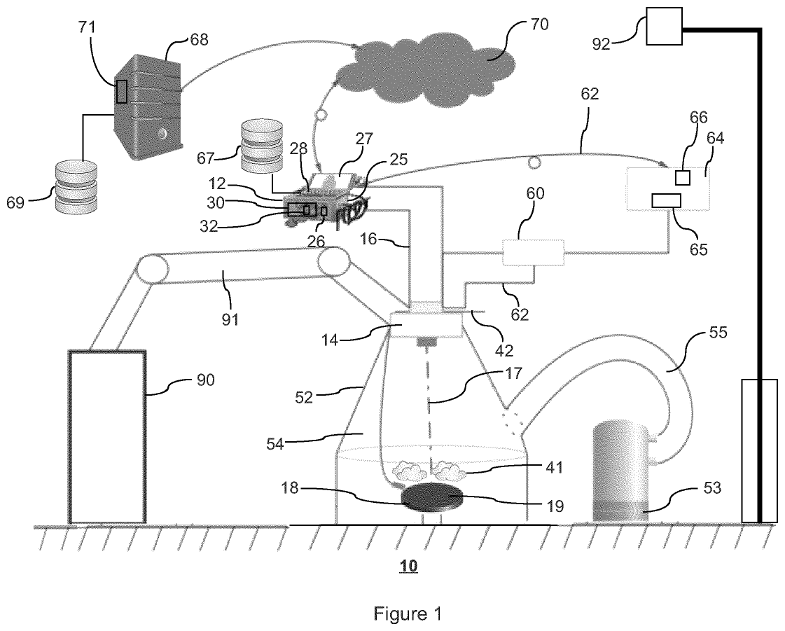

FIG. 1 shows a laser ablating system, generally identified by numeral 10, in an exemplary embodiment. Laser ablating system 10 comprises laser 12 coupled to laser ablating head 14 via fibre optic cable 16 transmitting laser light 17 to substrate material 18 having layer 19 to be ablated via optical assembly 20. Associated with laser ablating head 14 are sensor means 22 for detecting emitted sound and capture images in the immediate vicinity of substrate material 18 being cleaned, and detection means 24 for characterizing the spectra emitted during the ablation event. Application programs executed by computing means 25 are configured to control laser 12, ablating head 14, sensor means 22, detection means 24, and optical assembly 20. Computing means 25 comprises processor 26, display means 27 and input means 28 and communications interface 29. Display means 27 displays a graphical user interface (GUI) associated with the application programs and calibration settings or parameters associated with an ablation event.

In more detail, in an exemplary implementation laser light 17 is outputted by laser 12 powered by power supply 30 under the control of power controller 32. Accordingly, power controller 32 adjusts the repetition rate and pulse width of laser 12 by following instructions from computing means 25. The output level may be set between a predetermined range having a lower threshold and a higher threshold to minimize damage to substrate material 18. The pulse width is also maintained within a predetermined range having a lower and higher threshold to minimize damage to fiber optic cable 16. Accordingly, the parameters of laser beam 17 are selected to optimize the average energy density (energy per unit area) on substrate material 18 while minimizing excessive thermal diffusion into substrate material 18. Accordingly, peripheral damage of substrate material 18 is minimized. In one exemplary implementation, the power output level is set at 80 watts (W), at a frequency of 400 kilohertz (kHz), with a pulse width at 350 ns. Fiber cable 16 from laser 12 terminates at laser ablating head 14 having internal optical assembly 20 comprising lens 40 which focuses laser light 17 on substrate material 18 to remove a layer or coating 19 off substrate material 18. Other focusing and beam processing components of optical assembly 20 may be used to achieve focused laser beam 17 having the desired beam energy density, and shape. When the focused pulsed laser 17 strikes substrate material 18, photons from the pulsed laser 17 are absorbed by solid substrate material 18 and cause a photochemical excitation of electrons from their equilibrium states to some excited states, thereby atomizing substrate material 18 and/or layer 19. Ultrasonic waves and plasma plume (partially ionized gas) 41 having various spectral components are emitted during this process.

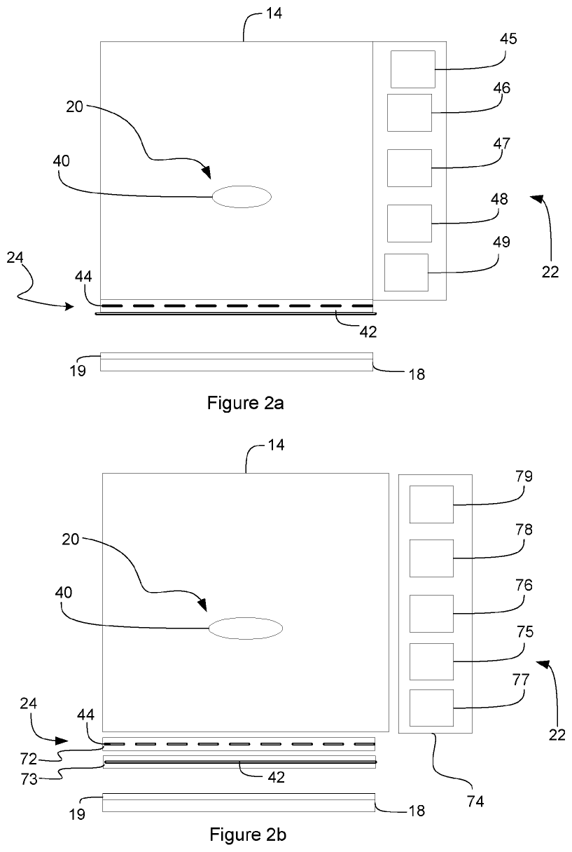

Looking at FIGS. 1 and 2a, laser ablating head 14 comprises shutter 42, sensor means 22, and collimator lens 44 associated with detection means 24, and display means 45. Sensor means 22 comprises acoustic detector such as ultrasound detector 46 under the control of a microcontroller, image capture device 47, thermal imaging sensor 48, microphone 49, and associated driving circuit.

The laser ablation process occurs within enclosed chamber 52 to contain plasma plume 41, and fume extractor 53 is connected to interior 54 of chamber 52 via fume hose 55 to remove any gaseous by-products of the ablation event.

Detector means 24 comprises optical combiner 60 which receives emitted electromagnetic waves from collimator lens 44 via second fiber optic cable 62 and transmits the emitted electromagnetic waves to spectrometer 64 for substances identification. In one example, spectrometer 64 is integrated with a laser-induced breakdown spectroscopy (LIBS) system for characterization of substrate material 18. Plasma plume 41 comprises atomized and partially ionized matter constituting substrate material 18 and layer sample 19, whose atoms and ions emit characteristic spectral lines for each element when they return to their ground state. The emitted light is transmitted through optical fibers and the polychromatic radiation is dispersed in one or more spectrometers 34 by diffraction gratings 65. The light is imaged onto charge-coupled device (CCD) 66, and the photons are then converted into electrons which are digitized into spectral data.

Computing means 25 receives an output from CCD 66 and employs algorithms and program instructions stored in a computer-readable medium to recognize the spectrum lines of the plasma radiation for laser ablating system 10 incorporating the LIBS system. The algorithms and program instructions then interpolate the signal based on the number of pixels in CCD 66 and the linear dispersion of the diffraction gratings 65 to create a calibration that enables the data to be plotted as a function of wavelength over the given spectral range. The spectral information includes intensity data representing elemental information and composition of layer 19 and substrate material 18. Local database 67 and computing means 25 may be coupled to one or more server computers 68 and master database 69 via a communication network 70, and databases 67, 69 store spectra data, calibration curves and laser ablating operating parameters for a plethora of substrate materials 18, and coatings 19, and may include calibration-free LIBS for implementing an automated system. When the settings for a particular material 18 is unknown or cannot be found in database 67, then computing means 25 queries master database 69 to update the settings of local database 67. Accordingly, computing means 25 causes processor 26 to execute program instructions to control the output power of laser 12 based on the appropriate settings for detected substrate material 18, thus completing a feedback loop. Computing means 25 and/or one or more server computers 68 are associated with cognitive element 71, such as an artificial intelligence (AI) engine, with instructions executable by processor 26 to perform comparisons between the acquired spectral data and stored spectral data to determine the identity of substrate material 18 and/or layer 19, and output the requisite calibration settings or parameters for laser head 14, as will be described in more detail later.

In another implementation, laser head 14 comprises detachable collimator lens holder 72 for retaining collimator lens 44, shutter holder 73 for retaining shutter 42, such that holders 72, 73 are peripherals to laser ablating system 10, as shown in FIG. 2b. In addition, another peripheral 74 comprises at least one of a microphone 75 and ultrasound sensor 76 of sensor means 22, image capture device 77, display means 78 and thermal imaging sensor 79.

The sound signals emitted during the interaction of laser beam 17 and layer 19 and/or substrate material 18 are detected by ultrasound transducer 46 or 76 and converted into acoustic data by computing means 25. The ultrasonic data is used to measure the distance between laser head 14 and substrate material 18, and the measured distance is further displayed on display means 45 or 78. These distance measurements facilitate focusing of laser beam 17 on substrate material 18 and enhances quality assurance. In addition, image capture device 47 or 77 captures images of substrate material 18 and layer 19 during the ablating event and present the images on display means 45 or 78 for viewing by a user to further facilitate focusing of laser beam 17 and enhance quality assurance. Thermal imaging sensors 48, 79 detect differences in infrared energy of substrate material 18 before, during, and after the ablating process, for input into computing means 25 and/or server computers 68 to measure the temperature, and also create color or greyscale images. The temperature measurements may be used by computing means 25 and/or server computers 68, or in conjunction with cognitive element 71, to control laser 12 to maintain the temperature of substrate material 18 within a pre-defined range.

In another implementation, laser head 14 is controlled by robotic positioning system 90, such that laser head 14 can trace complex structures in order to clean a predetermined surface area of substrate material 18 with laser beam 17 having a predefined width and shape suitable for the size and shape of complex structure or object to be cleaned. As an example, a 3D perception sensor and associated processor-executable instructions generate an optimal laser beam shape according to a 3D perception reconstruction of the object sent to laser scanner head 14. The outputted laser beam 17 may be a line or circle or an elliptical or any other form, of any appropriate size e.g. from a few mm to 12 cm.

Referring once again to FIG. 1, robotic positioning system 90 comprises robotic arm 91 and associated servo-controllers and associated motors and actuators to move laser head 14 in x-y directions of a plane and in a z-direction perpendicular to the plane during an ablating event. Accordingly, feedback from sensor means 22 and detector means 24 is employed by computing means 25 to provide control signals to servo-controllers and associated motors and actuators to move laser head 14 during the ablating event.

In another implementation, cognitive element 71 comprises instructions executable by processor 26 associated with server computers 68, and may be configured to receive inputs from any one of computing means 25, one or more server computers 68, laser 12, laser head 14, robotic positioning system 90, sensor means 22, detector means 24 to make decisions based on these inputs, thus enabling system 10 to dynamically adapt to varying conditions during the ablation event. Accordingly, cognitive element 71 may be configured to output instructions for actions, based on the dynamic decisions, to any one of computing means 25, one or more server computers 68, laser 12, laser head 14, robotic positioning system 90, sensor means 22, and detector means 24. Any one of computing means 25, one or more server computers 68, laser 12, laser head 14, robotic positioning system 90, sensor means 22, detector means 24 may be configured to receive and follow the dynamic output instructions as commands from cognitive element 71.

In another implementation, cognitive element 71 receives inputs from any one of computing means 25, one or more server computers 68, laser 12, laser head 14, robotic positioning system 90, sensor means 22, detector means 24, which enables cognitive element 71 to monitor the ablation event, and based on predefined rule sets, automatically perform modifications to the operating parameters or calibration settings or parameters based on historical data and previous outcomes and knowledge and issue the requisite commands to any one of computing means 25, one or more server computers 68, laser 12, laser head 14, robotic positioning system 90, sensor means 22, detector means 24, in order to achieve the desired quality requirements. This ability of cognitive element 71 to perceive the particular ablating environment and conditions, and adapt to the dynamic conditions accordingly by modifying the operating parameters on the fly, and learn to optimize future decisions and cognitive actions results in an intelligent laser ablating system requiring minimal human supervision or intervention.

In one implementation, raw data from the various components during the ablation event is collected, pre-processed and structured for cognitive element 71. The structured data is fed into one or more machine learning algorithms as training data to generate several models for predicting the calibration settings or parameters associated with particular substrate materials 18 and layers 19. Multiple supervised machine learning algorithms are trained using past data for predictions, such as, XGBoost, Neural Networks, Random Forest, and Logistic Regression model, among others. As an example, the XGBoost algorithm is able to automatically handle missing data values, and therefore it is sparse aware, includes block structure to support the parallelization of tree construction, and can further boost an already fitted model on new data i.e. continued training. In one example, an XGBoost classifier may be trained by randomly splitting the training data into three parts or sets: training, validation, and testing, such that 80-90% of the data may be in the training set, 5% may be in the validation set and 15-5% of the data may be in the testing set. The training process may be run iteratively by observing patterns in data and making estimated decisions. The validation set is used to measure accuracy during training and make adjustments (if needed) to correct and improve the modeling complexity for the next iteration. This iterative refinement can then be repeated, and the training process may stop when a certain criterion is satisfied. In one embodiment, the stopping criteria is reached as certain errors are minimized. The resulting classifier can then be evaluated, utilizing several performance metrics, (e.g., Area Under Curve of Receiver Operating Characteristic or Precision/Recall curves, minimum per-class accuracy, F1, F2, FN scores, Sensitivity/Specificity, etc.). A proper threshold may then be selected to maximize performance and/or predictions.

In another implementation, system 10 comprises monitoring and safety camera system 92 which is capable of detecting any human intervention during the ablating process, by surveilling laser ablating system 10 site or location. When human intervention is detected then the ablating process is terminated and laser 12 is shut down for safety reasons.

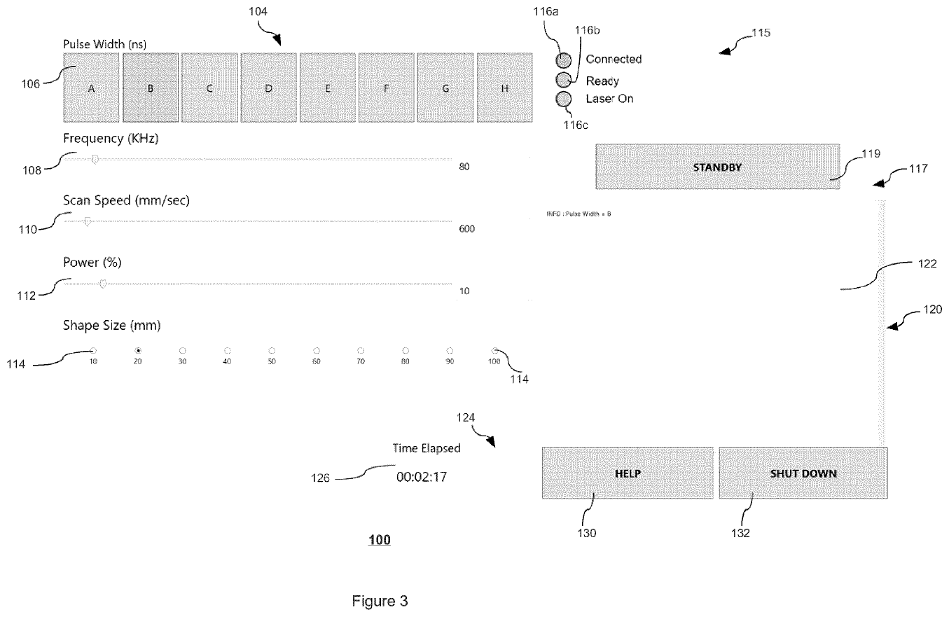

Looking at FIG. 3, there is shown a laser ablating graphical user interface (GUI) 100 associated with laser ablating application programs executed by computing means 25. GUI 100 is displayed to a user on display means 27 and comprises a plurality of controlled or monitored parameters than can be defined by the user and a plurality of GUI elements such as command buttons and status indicators. In one exemplary implementation, one portion 104 of GUI 100 includes the controlled or monitored parameters such as: “Pulse Width” 106 having button options associated with a particular pulse width (ns); “Frequency” 108 with a slider for selecting frequencies ranging from 40 kHz to 1,000 kHz; “Scan Speed” 110 with a slider that can be set to a maximum of 10,000 mm/sec; “Laser power level” 112 with a slider ranging from 10% to 100% of the total power, e.g. 100 W; and “Laser Pattern Size” 114 with a plurality of radio button for selecting shape choices 114, and the laser pattern size ranging from 10 mm to 100 mm.

GUI 100 also comprises portion 115 with laser status conditions such as “Connected” indicator 116a, “Ready” indicator 116b and “Laser on indicator” 116c. Portion 117 includes running mode button 119 which starts off in ‘Listen” mode, which allows a user to modify the operating parameters or calibration settings, followed by a “Standby” mode which locks the set operating parameters, and finally the “Laser Emission” mode is activated to initiate the actual ablating event. Another portion 120 comprises status dialog box 122 which is populated with a log of commands sent to laser 12, shows the current status of laser 12. GUI portion 124 includes cumulative counter 126 displaying the time elapsed during the emission mode; and GUI portion 128 includes “HELP” button 130 which invokes remedial actions for known or common issues that may be encountered when operating system 10, and “SHUTDOWN” button 132 to terminate the GUI laser ablating application program. This button may be disabled during the emission mode.

The tables below show test results obtained using system 10 to remove a variety of layers 19, such as paint, lead paint, resin, mold release agent, rust, nuclear contamination, anodized automobile paint, from different substrate materials 18, such as metallic surfaces e.g. an aluminum plate, a steel plate, a chromium plate, or a concrete block.

TABLE 1
White paint on a Boeing 737 fuselage

| | | | | | | | Quality | |
|---|---|---|---|---|---|---|---|---|
| | | | | | | | observed; | |
| | Pulse | | Scan | | Shape | | Great, good, | |
| Test | Width | Frequency | Speed | Power | size | No. of | medium, bad, | Area/t |
| # | (ns) | (KHz) | (mm/s) | (%) | (mm) | passes | not good | (mm²)/s |
| 1 | 350 | 20 | 5000 | 100 | 10 | 6 | non- | 50000 |
| | | | | | | | penetrating | |
| 2 | 350 | 50 | 500 | 100 | 10 | 6 | non- | 5000 |
| | | | | | | | penetrating | |
| 3 | 350 | 50 | 500 | 100 | 10 | 15 | Smooth | 5000 |
| 4 | 350 | 50 | 500 | 100 | 10 | 1 | smooth | 5000 |
| 5 | 350 | 50 | 500 | 100 | 10 | 1 | smooth | 5000 |

The results of Table 1 were obtained by laser head 14 being manually operated by a user to perform passes on substrate material 18.

TABLE 2
Resin on an aluminum substrate with grid feature

| | Pulse | | Scan | | | |
|---|---|---|---|---|---|---|
| Test | Width | Frequency | Speed | Power | No. of | Area/t |
| # | (ns) | (KHz) | (mm/s) | (%) | passes | (mm²)/s |
| 1 | 350 | 80 | 9000 | 80 | 1 | — |
| 2 | 350 | 200 | 9000 | 80 | 1 | 3150000 |
| 3 | 350 | 300 | 9000 | 80 | 1 | 3150000 |
| 4 | 350 | 400 | 9000 | 80 | 1 | 3150000 |
| 5 | 350 | 70 | 9000 | 80 | 1 | 3150000 |

TABLE 3
Mold release agent on an aluminum substrate with grid feature

| | Pulse | | Scan | | | |
|---|---|---|---|---|---|---|
| Test | Width | Frequency | Speed | Power | No. of | Area/t |
| # | (ns) | (KHz) | (mm/s) | (%) | passes | (mm²)/s |
| 1 | 350 | 80 | 9000 | 80 | 1 | 6400 |
| 2 | 350 | 200 | 9000 | 80 | 1 | 16000 |
| 3 | 350 | 300 | 9000 | 80 | 1 | 24000 |
| 4 | 350 | 400 | 9000 | 80 | 1 | 32000 |
| 5 | 350 | 70 | 9000 | 80 | 1 | 5600 |

TABLE 4
Lead paint on a steel plate

| | | | | | | Quality | |
|---|---|---|---|---|---|---|---|
| | | | | | | observed; | |
| | Pulse | | Scan | | Shape | Great, good, | |
| Test | Width | Frequency | Speed | Power | size | medium, bad, | Area/t |
| # | (ns) | (KHz) | (mm/s) | (%) | (mm) | not good | (mm²)/s |
| 1 | 350 | 80 | 9000 | 80 | 20 | good | 20.5 |
| 2 | 350 | 300 | 9000 | 80 | 20 | bad | 20.5 |
| 3 | 350 | 70 | 9000 | 80 | 20 | bad | 20.5 |
| 4 | 350 | 20 | 9000 | 80 | 20 | bad | 20.5 |

TABLE 5
Rust on chrome wheels

| | | | | | | Quality | |
|---|---|---|---|---|---|---|---|
| | | | | | Size | observed; | |
| | Pulse | | Scan | | Shape | Great, good, | |
| Test | Width | Frequency | Speed | Power | size | medium, bad, | Area/t |
| # | (ns) | (KHz) | (mm/s) | (%) | (mm) | not good | (mm²)/s |
| 1 | 10 | 999 | 5000 | 50 | 50 | light etching | — |
| 2 | 60 | 220 | 10000 | 90 | 20 | light etching | 19800 |
| | | | | | | but good | |
| 3 | 30 | 550 | 10000 | 90 | 20 | extra light | 49500 |
| | | | | | | etching | |
| | | | | | | but good | |
| 4 | 20 | 850 | 10000 | 90 | 20 | perfect | 76500 |
| 5 | 10 | 999 | 10000 | 90 | 20 | — | 89910 |

TABLE 6
Anodized automobile paint on a steel plate

| | | | | | | Quality | |
|---|---|---|---|---|---|---|---|
| | | | | | | observed; | |
| | Pulse | | Scan | | | Great, good, | |
| Test | Width | Frequency | Speed | Power | No. of | medium, bad, | Area/t |
| # | (ns) | (KHz) | (mm/s) | (%) | passes | not good | (mm²)/s |
| 1 | 100 | 400000 | 90000 | 60 | — | smooth | — |
| 2 | 350 | 80000 | 90000 | 50 | — | loosened paint, | — |
| | | | | | | anodizing kept | |
| 3 | 350 | 80000 | 9000 | 40 | 2 | loosened paint, | — |
| | | | | | | anodizing kept | |

The results of Table 6 were obtained by a laser head 14 being operated by robotic positioning system 90 to perform passes on substrate material 18.

In one exemplary implementation, system 10 is used to remove nuclear radiation from a contaminated machine. Several hot spots on the machine were identified before the ablation process, and the following readings were recorded before the laser ablation process using a Ludlum Model 2929 Radiation Monitor: βγ≤25,000 cpm D/C, γ<1.0 mrem/h N/C; and after the laser ablation process lasting about 3 hours the following readings were recorded: βγ≤4,000 cpm D/C.

In another exemplary implementation, system 10 is used to remove nuclear radiation, such as Co-60, Cs-137, Cs-134, Zn-65, on the metallic surfaces, such as iron, steel aluminum, Inconel®, painted or non-painted stainless steel (e.g. SUS304), or on concrete. The results of Table 7 were obtained by laser head 14 being operated to perform passes on several substrate materials 18, by modifying parameters, power level, pulse duration, scan speed, repetition rate, shape and size of the beam, and the duration of the pass. As concrete is of a porous composition, it was only after multiple passes of the laser that the section of the previously contaminated concrete was found to be less than detection and meet the release limit criteria. As metal is not nearly as porous as concrete and the contamination tends to stay closer to the surface, accordingly a laser removing a very fine amount of surface area can be effective. For the jackhammer sleeves, the power was set at 100% and after two passes the material was less than the detection level and met the release limit.

The C-clamps were made of a more hardened steel and since the tool could possibly be re-used for its intended purpose, decontamination without damage to the tool was desirable. After adjusting to 100% power and making a second pass, the threads on the C-clamp were found to be below detection levels and met the release limit. The stainless-steel tote lid was tested. Stainless steel has the tendency to be more complicated or resistant than other metal to decontamination technique. However, the materials tested were decontaminated successfully. The steel plate had the highest level of contamination present and as a result required three passes at full power, the steel plate also had 200 dpm alpha contamination which was successfully removed. The lead blanket could not be decontaminated with the laser unit because the fiber encasement of the lead itself is comprised of plastic and would only melt in contact with the laser even at only 30%.

TABLE 7
Radioactive material various substrates

| | | | | Beta | |
|---|---|---|---|---|---|
| | Beta | | Laser | Contam- | |
| | Contam- | | Power | ination | |
| | ination | Pass | Setting | Post | % |
| Item | (dpm)* | #** | %** | (dpm)* | Reduction*** |
| Concrete | 5,000 | 1 | 30% | 4,000 | 20% |
| Ecology | | 2 | 60% | 2,000 | 60% |
| Block | | 3 | 80% | 1,000 | 80% |
| | | 4 | 80% | <1,000 | Below |
| | | | | | Detect |
| Metal Jack | 5,000 | 1 | 100% | 2,000 | 60% |
| Hammer | | 2 | 100% | <1,000 | Below |
| Sleeve | | | | | Detect |
| (spot 1) | | | | | |
| Metal Jack | 3,000 | 1 | 100% | 2,000 | 67% |
| Hammer | | 2 | 100% | <1,000 | Below |
| Sleeve | | | | | Detect |
| (spot 2) | | | | | |
| Metal C- | 5,000 | 1 | 90% | 4,000 | 20% |
| Clamp | | 2 | 100% | <1000 | Below |
| threads | | | | | Detect |
| Metal C- | 10,000 | 1 | 90% | 2000 | 80% |
| Clamp | | 2 | 100% | <1000 | Below |
| frame | | | | | Detect |
| Brass/copper/ | 15,000 | 1 | 70% | 5000 | 67% |
| metal Cutting | | 2 | 100% | 4,000 | 73% |
| Torch head | | | | | |
| Steel Plate | 30,000 | 1 | 100% | 20,000 | 33% |
| | | 2 | 100% | 10,000 | 67% |
| | | 3 | 100% | 4,000 | 87% |
| Stainless | 3,000 | 1 | 100% | <1,000 | Below |
| Steel Tote | | | | | Detect |
| Lid | | | | | |
| Enclosed | 10,000 | 1 | 30% | 10,000 | 0% |
| fiber Lead | | | | | |
| Blanket | | | | | |

TABLE 8
Comparison of various cleaning techniques

| Cleaning | Laser | | | Glass | Walnut | | | |
|---|---|---|---|---|---|---|---|---|
| Technique | cleaning | Dry Ice | Sand | Beads | Shells | Water | Steam | Solvents |
| Waste for | NO | NO | YES | YES | YES | YES | NO | YES |
| Disposal | | | | | | | | |
| Abrasive | NO | NO | YES | YES | YES | NO | NO | NO |
| Toxic Waste | NO | NO | YES | YES | YES | YES | NO | YES |
| Electrically | NO | NO | NO | NO | NO | YES | YES | YES |
| Conductive | | | | | | | | |
| Consumable | NO | YES | YES | YES | YES | YES | YES | YES |
| needed | | | | | | | | |
| Other gear | NO | YES | YES | YES | YES | NO | YES | YES |
| required | | | | | | | | |
| Preparation | NO | NO | YES | YES | YES | YES | YES | YES |
| intensive | | | | | | | | |
| Environment | YES | CO2 No | NO | NO | NO | NO | NO | NO |
| friendly | | | | | | | | |
| Noisy | Very | Very | Very | Very | High | High | Medium | Low |
| | low | high | high | high | | | | |
| Vibration | NO | YES | YES | YES | YES | YES | Medium | YES |
| Dry process | YES | YES | YES | YES | YES | NO | NO | NO |
| Hazardous | Low | High | Very | Very | Very | High | High | Medium |
| | | | high | high | high | | | |
| Cause | NO | YES | YES | YES | YES | YES | YES | NO |
| airborne | | | | | | | | |
| particles | | | | | | | | |
| At-line-online | YES | NO | NO | NO | NO | YES | NO | NO |
| cleaning | | | | | | | | |
| Work on hot | YES | Sometime | YES | YES | YES | NO | YES | NO |
| or cold | | | | | | | | |
| surface | | | | | | | | |
| Extra Nozzle | NO | YES | YES | YES | YES | YES | YES | NO |
| or tools to | | | | | | | | |
| shape flow | | | | | | | | |
| Performance | Excellent | Great | OK | OK | Limited | OK | Poor | Limited |
| Comparison | | | | | | | | |

Some of the advantages of laser decontamination are: reduction of the total effective cost per sq/ft by 40% to 60% depending on the material; labor cost reduction, typically only one operator performs the cleaning process; reduced power consumption; reduction of the time of decontamination by approximately 80%; scheduling for the cleaning process can be performed without the need for burdensome planning involving equipment and personnel resources; minimization of damage to the material base substrate; no need for water, thereby avoiding water infiltration; no need for chemicals; reduction of toxic waste disposal cost by at least 90%, i.e. solvent, media blasting and liquid waste; reduced risk of injury at work; environmental friendly; reduction in injury rate; reduced cost of protective clothing; increase in the lifetime of the substrate being ablated; zero consumables; zero preparation cost, and ability to decontaminate a wide variety of materials and equipment. In addition, laser ablation is effective and provides a safer operation for the personnel who get exposed to less secondary pollution.

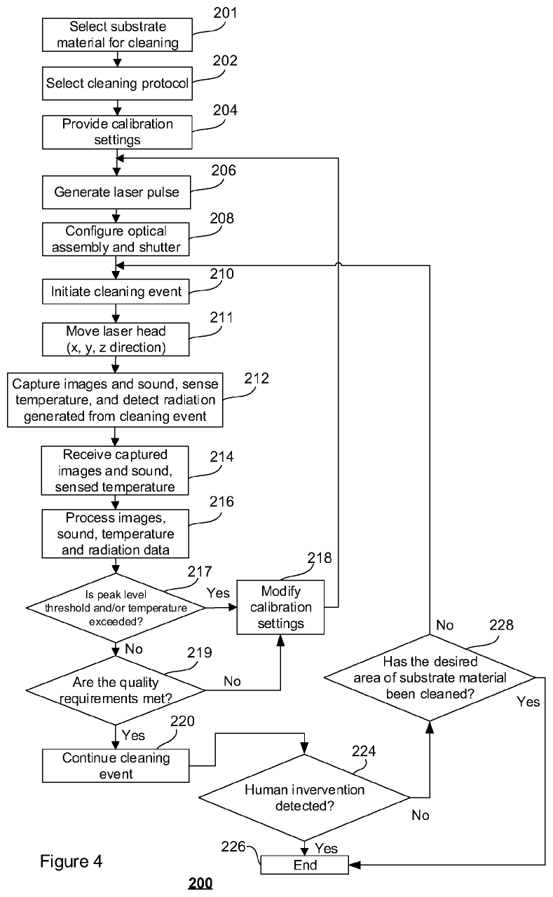

FIG. 4 shows high-level flow diagram 200 illustrating exemplary process steps for laser ablating substrate material 18 having a layered coating 19 using laser ablating apparatus 10. Starting at step 201, substrate material 18 to be cleaned is selected, and based on the known characteristics of substrate material 18 and/or layer 19, an appropriate ablating protocol is selected via graphical user interface 100 associated with computing means 25, step 202. The appropriate ablating protocol may include parameters pertaining to the characteristics of laser beam 17, such as pulse width, frequency, scan speed, power level and shape size, as described above. The characteristics of substrate material 18 may include type of material e.g. aluminum, steel, plastic, fiberglass etc., and characteristics of layer 19 may include any one of paint, lead paint, resin, mold release agent, rust, nuclear contamination, anodized automobile paint, among others. Layer 19 may include multiple layers of the same coating or different coatings. The depth of the laser ablation may be determined by laser beam 17 pulse duration, laser beam 17 energy density, and laser beam 17 wavelength. In step 204, program instructions of the application software running on computing means 25 are executed by processor 26 associated with computing means 25 to provide calibration settings or desired parameters for the selected ablating protocol, and to transmit commands to laser power controller 32 and laser head 14, via communications interface 29. Next, laser pulse 17 having a particular wavelength, pulse width and output level is generated and transmitted to laser head 14 by optical fiber 16, in step 206. The components of optical assembly 20 and shutter 42 are configured to transmit laser light 17 to achieve a desired shape and focused beam on substrate material 18, in step 208. As noted above, the laser beam width and shape may be adjusted according to the size and shape of an object to be cleaned. For example, a 3D perception sensor and associated processor-executable instructions generate an optimal laser beam shape according to the 3D perception reconstruction of the object sent to laser scanner head 14. The outputted laser beam 17 may be a line or circle or an elliptical or any other form, of any appropriate size e.g. from a few mm to 12 cm.

Next, the ablating event is initiated and laser beam 17 impinges substrate material 18 with layer 19 to cause plasma plume (partially ionized gas) 41 to be emitted during the process, in step 210. Laser head 14 is moved in any one of a x, y and z direction, depending on the structural shape of substrate material 18 to remove layer 19, in step 211.

In step 212, sensor means 22, such as ultrasound detector 46, microphone 49 pick up the acoustic waves emitted during the ablating process, thermal imaging sensor 48 detects infrared energy, and image capture device 47 captures images of substrate material 18 undergoing the ablating, and the acquired image data, thermal data, and acoustic data is transmitted to computing means 25. Detector means 24 receives emitted light of plasma plume 41 from collimator lens 44 via fiber optic cable 62 for spectra identification by spectrometer 64, in step 214. Next, computing means 25 receives spectral information from the spectrometer 64 and CCD 66 of detector means 24 and employs algorithms and program instructions stored in a computer-readable medium to recognize the spectrum peaks and levels of the spectrum peaks of the plasma radiation for laser ablating system 10 incorporating the LIBS system, in step 216. Next, a determination is made regarding whether the detected peak levels exceed a predefined threshold, or whether the sensed temperature of substrate material 18 is outside a predefined range, in step 217. When the detected peak levels exceed a predefined threshold or when the sensed temperature of substrate material 18 is outside a predefined range, then the ablating event may be halted and the process proceeds to step 218 to modify the calibration settings or desired parameters, and the process returns to step 206. Cognitive element 71 associated with computing means 25 and one or more server computers 68 perceives the particular ablating environment and conditions, and adapts to the dynamic conditions accordingly by modifying the operating parameters on the fly. Therefore, when the detected peak levels do not exceed the predefined threshold, or the sensed temperature of substrate material 18 is not outside a predefined range, then the ablating event continues to step 219, in which computing means 25 and associated cognitive element 71 determine whether the desired quality requirements are met, that is whether the layer 19 is being removed as planned and whether there is any undesirable damage to substrate material 18 based on the spectral information. When the desired quality assurance is met or within an acceptable range, then the ablating process continues, in step 220; else when the desired quality assurance is not met or is not within an acceptable range then calibration settings or desired parameters are adjusted or another set of calibration settings or desired parameters are selected, in step 218, and the ablating process returns to step 206. Therefore, cognitive element 71 self-learns from each ablating event and optimizes of the quality of the cleaning without human intervention.

From step 220, a determination is made regarding whether human intervention has been detected, in step 222. When human intervention has been detected, the ablating process is terminated and laser 12 is shut down, in step 226; else the process proceeds to step 228.

A determination is made regarding whether the desired area of substrate material 18 has been cleaned in accordance with a desired level of ablation and quality based on any one of the analyzed image, acoustic, thermal, and spectra data from the sensor means 22 and detector means 24, in step 228. When it is determined that the desired area of substrate material 18 has not been cleaned, the process returns to step 210; else the ablating process ends in step 226.

In one implementation, determination step 217 of FIG. 4 may include an option to terminate the ablation event, shut down the laser ablating system 10, when the threshold level is exceeded, either after a single measurement or after a predetermined number of measurements following modifications of the calibration settings.

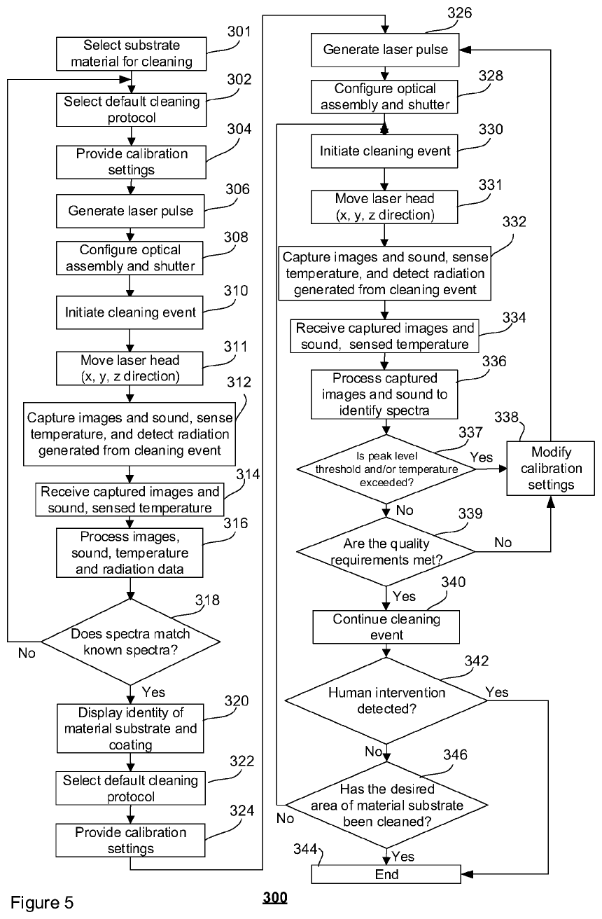

In another implementation, FIG. 5 shows high-level flow diagram 300 illustrating exemplary process steps for laser ablating an unknown substrate material 18 having an unknown layer 19 using laser ablating apparatus 10. Starting at step 301, substrate material 18 to be cleaned is selected, and based on the known characteristics of substrate material 18 and/or layer 19, an appropriate ablating protocol is selected via graphical user interface 100 associated with computing means 25, step 302. The appropriate ablating protocol may include parameters pertaining to the characteristics of laser beam 17, such as pulse width, frequency, scan speed, power level and shape size, as described above. The characteristics of substrate material 18 may include type of material e.g. aluminum, steel, fiberglass etc., and characteristics of layer 19 may include any one of paint, lead paint, resin, mold release agent, rust, nuclear contamination, anodized automobile paint, among others. Layer 19 may include multiple layers of the same coating or different coatings. In step 304, program instructions of the application software running on computing means 25 are executed by processor 26 associated with computing means 25 to provide calibration settings or desired parameters for the selected ablating protocol, and to transmit commands to laser power controller 32 and laser head 14, via communications interface 29. Next, laser pulse 17 having a particular wavelength, pulse width and output level is generated and transmitted to laser head 14 by optical fiber 16, in step 306. The components of optical assembly 20 and shutter 42 are configured to transmit laser light 17 to achieve a desired shape and focused beam on substrate material 18, in step 308. Next, the ablating event is initiated and laser beam 17 impinges substrate material 18 with layer 19 to cause plasma plume (partially ionized gas) 41 to be emitted during the process, in step 310. Laser head 14 is moved in any one of a x, y and z direction, depending on the structural shape of substrate material 18 to remove layer 19, in step 311.

In step 312, sensor means 22, such as ultrasound detector 46, microphone 49 pick up the acoustic waves emitted during the ablating process, thermal imaging sensor 48 detects infrared energy, and image capture device 47 captures images of substrate material 18 undergoing the ablating, and the acquired image data, thermal data, and acoustic data is transmitted to computing means 25. Detector means 24 receives emitted electromagnetic waves of plasma plume 41 from collimator lens 44 via second fiber optic cable 62 for spectra identification by spectrometer 64, in step 314. Next, computing means 25 receives spectral information from the spectrometer 64 and CCD 66 of detector means 24 and employs algorithms and program instructions stored in a computer-readable medium to recognize the spectrum lines of the plasma radiation for laser ablating system 10 incorporating the LIBS system and automated system, in step 316. Using the acquired spectra data, computing means 25 queries database 67 or 69 to determine if the acquired spectra data corresponds to any of the stored spectra data attributed to known substrate materials 18 and coatings 19 in database 67 or 69, in step 318.

If there is no match in step 318, then another ablating protocol is selected in step 302 such that another laser pulse having a particular wavelength, pulse width and output level is generated and transmitted to laser head 14 for a new ablating event is initiated and once again in step 318 a determination is made regarding whether the acquired spectra data corresponds to any of the stored spectra data attributed to known substrate materials 18 and coatings in database 67 or 69. The process repeats until there is a match or until a close match is found, alternatively if there is no match or no close matches are found after a predetermined number of attempts, then the process ends.

In step 318, if there is a match then the characteristics of substrate material 18 e.g. aluminum, steel etc., and characteristics of layer 19 e.g. paint, lead paint, resin, mold release agent, rust, nuclear contamination, anodized automobile paint, among others may be presented on display means associated with computing means 25, step 320. Next, based on the identified substrate material 18 and layer 19, an appropriate ablating protocol is selected, step 322. In step 324, program instructions of application software running on computing means 25 are executed by processor 26 associated with computing means 25 and provides calibration settings or desired parameters for the selected ablating protocol to laser power controller 32 and laser head 14.

Next, laser pulse 17 having a particular wavelength, pulse width and output level is generated and transmitted to laser head 14 by optical fiber 16, in step 326. The components of optical assembly 20 and shutter 42 are configured to transmit laser light 17 to achieve a desired shape and focused beam on substrate material 18, in step 328. Next, the ablating event is initiated and laser beam 17 impinges layer 19 on substrate material 18 to cause plasma plume (partially ionized gas) 41 to be emitted during the process, in step 330. Laser head 14 is moved in any one of a x, y and z direction, depending on the structural shape of substrate material 18 to remove layer 19, in step 331.

In step 332, sensor means 22, such as ultrasound detector 46, microphone 49 pick up the acoustic waves emitted during the ablating process, thermal imaging sensor 48 detects infrared energy, and image capture device 47 captures images of substrate material 18 undergoing the ablating process, and the acquired image data, thermal data, and acoustic data is transmitted to computing means 25. Detector means 24 receives emitted electromagnetic waves of plasma plume 41 from collimator lens 44 via second fiber optic cable 62 for spectra identification by spectrometer 64, in step 334. Next, computing means 25 receives spectral information from the spectrometer 64 and CCD chips 66 of detector means 24 and employs algorithms and program instructions stored in a computer-readable medium to recognize the spectrum lines of the plasma radiation for laser ablating system 10 incorporating the LIBS system, in step 336.

Next, a determination is made regarding whether the detected peak levels exceed a predefined threshold, or whether the sensed temperature of substrate material 18 is outside a predefined range, in step 337. When the detected peak levels exceed a predefined threshold or the sensed temperature of substrate material 18 is outside a predefined range, then the ablating event the process proceeds to step 338 to modify the calibration settings or desired parameters, and the process returns to step 326. Cognitive element 71 associated with computing means 25 and one or more server computers 68 perceives the particular ablating environment and conditions, and adapts to the dynamic conditions accordingly by modifying the operating parameters on the fly. Therefore, when the detected peak levels do not exceed the predefined threshold, or the sensed temperature of substrate material 18 is not outside a predefined range, then the ablating event continues to step 339, in which computing means 25 and associated cognitive element 71 determine whether the desired quality requirements are met, that is whether the layer 19 is being removed as planned and whether there is any undesirable damage to substrate material 18 based on the spectral information. When the desired quality assurance is met or within an acceptable range, then the ablating process continues, in step 340; else when the desired quality assurance is not met or is not within an acceptable range then calibration settings or desired parameters are adjusted or another set of calibration settings or desired parameters are selected, in step 338, and the ablating process returns to step 326. Therefore, cognitive element 71 self-learns from each ablating event and optimizes of the quality of the cleaning without human intervention.

From step 440, a determination is made regarding whether human intervention has been detected, in step 342. When human intervention has been detected, the ablating process is terminated and laser 12 is shut down, in step 344; else the process proceeds to step 346.

A determination is made regarding whether the desired area of substrate material 18 has been cleaned in accordance with a desired level of ablation and quality based on any one of the analyzed image, acoustic, thermal, and spectra data from the sensor means 22 and detector means 24, in step 346. When it is determined that the desired area of substrate material 18 has not been cleaned, the process returns to step 330; else the ablating process ends in step 344.

In one implementation, determination step 334 of FIG. 5 may include an option to terminate the ablation event, shut down the laser ablating system 10, when the threshold level is exceeded, either after a single measurement or after a predetermined number of measurements following modifications of the calibration settings.

In one implementation, the process steps of FIGS. 4 and 5 are semi-automated or fully automated.

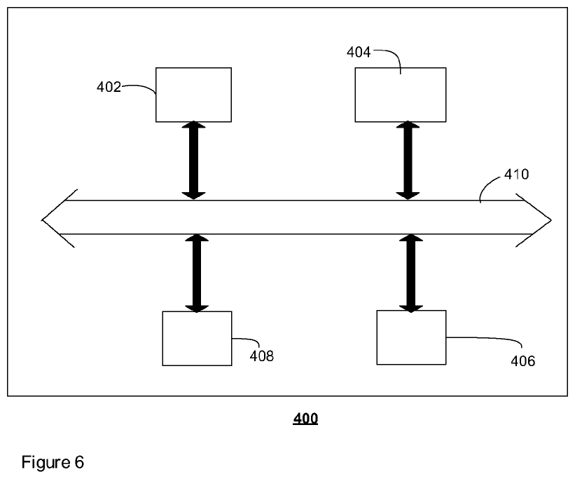

In one embodiment, computing means 25 and/or one or more server computers 68 include computing system 400 comprising at least one processor such as processor 402, at least one memory such as memory 404, input/output (I/O) module 406 and communication interface 408, as shown in FIG. 6. Although computing system 400 is depicted to include only one processor 402, computing system 400 may include more processors therein. In an embodiment, memory 404 is capable of storing instructions. Further, the processor 402 is capable of executing instructions.

In one embodiment, processor 402 may be configured to execute hard-coded functionality. In an embodiment, processor 402 may be embodied as an executor of software instructions, wherein the software instructions may specifically configure processor 402 to perform algorithms and/or operations described herein when the software instructions are executed.

In one embodiment, processor 402 may be embodied as a multi-core processor, a single core processor, or a combination of one or more multi-core processors and one or more single core processors. For example, processor 402 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, Application-Specific Standard Products (ASSPs), System-on-a-chip systems (SOCs), Complex Programmable Logic Devices (CPLDs), Graphics Processing Units (GPUs), and the like. For example, some or all of the device functionality or method sequences may be performed by one or more hardware logic components.

Memory 404 may be embodied as one or more volatile memory devices, one or more non-volatile memory devices, and/or a combination of one or more volatile memory devices and non-volatile memory devices. For example, memory 404 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY™ Disc), and semiconductor memories (such as mask ROM, PROM (programmable ROM), EPROM (erasable PROM), flash ROM, RAM (random access memory), etc.).

I/O module 406 is configured to facilitate provisioning of an output to a user of computing system 400 and/or for receiving an input from the user of computing system 400. I/O module 406 is configured to be in communication with processor 402 and memory 404. Examples of the I/O module 406 include, but are not limited to, an input interface and/or an output interface. Some examples of the input interface may include, but are not limited to, a keyboard, a mouse, a joystick, a keypad, a touch screen, soft keys, a microphone, and the like. Some examples of the output interface may include, but are not limited to, a microphone, a speaker, a ringer, a vibrator, a light emitting diode display, a thin-film transistor (TFT) display, a liquid crystal display, an active-matrix organic light-emitting diode (AMOLED) display, and the like. In an example embodiment, processor 402 may include I/O circuitry configured to control at least some functions of one or more elements of I/O module 406, such as, for example, a speaker, a microphone, a display, and/or the like. Processor 402 and/or the I/O circuitry may be configured to control one or more functions of the one or more elements of I/O module 406 through computer program instructions, for example, software and/or firmware, stored on a memory, for example, the memory 404, and/or the like, accessible to the processor 402.

Communication interface 408 enables computing system 400 to communicate with other entities over various types of wired, wireless or combinations of wired and wireless networks, such as for example, the Internet. In at least one example embodiment, the communication interface 408 includes a transceiver circuitry configured to enable transmission and reception of data signals over the various types of communication networks. In some embodiments, communication interface 408 may include appropriate data compression and encoding mechanisms for securely transmitting and receiving data over the communication networks. Communication interface 408 facilitates communication between computing system 400 and I/O peripherals.

In an embodiment, various components of computing system 400, such as processor 402, memory 404, I/O module 406 and communication interface 408 may be configured to communicate with each other via or through a centralized circuit system 410. Centralized circuit system 410 may be various devices configured to, among other things, provide or enable communication between the components (402-408) of computing system 400. In certain embodiments, centralized circuit system 410 may be a central printed circuit board (PCB) such as a motherboard, a main board, a system board, or a logic board. Centralized circuit system 410 may also, or alternatively, include other printed circuit assemblies (PCAs) or communication channel media.

It is noted that various example embodiments as described herein may be implemented in a wide variety of devices, network configurations and applications.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, server computers, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In one embodiment, laser ablating system 10 follows a cloud computing model, by providing an on-demand network access to a shared pool of configurable computing resources (e.g., servers, storage, applications, and/or services) that can be rapidly provisioned and released with minimal or nor resource management effort, including interaction with a service provider, by a user (operator of a thin client).

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order, or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A laser ablating system for ablating a substrate material with a layer material to be removed, the system comprising:
a processor;
a computer readable medium comprising at least one first set of program instructions executable by the processor to determine calibration parameters for ablating the substrate material;
a laser head associated with a laser power controller for generating a laser pulse based on the calibration parameters, wherein the laser pulse impinges the substrate material and the layer material, and emits a plasma plume and sound during an ablation event;
an optical fiber to transmit the laser pulse to the laser head having an optical assembly to shape and focus a beam of the laser pulse on the substrate material;
at least one sensor to capture light emitted by the plasma plume and sound emitted during the ablation event;
at least one second set of program instructions executable by the processor to determine spectrum peaks and levels from the emitted light and emitted sound and output spectral data and acoustic data; and
a cognitive element configured to process the spectral data and acoustic data over time and dynamically modify the calibration parameters at least in part responsive to the spectral data and sensor data, to meet desired quality requirements in the ablation event.

2. The system of claim 1, wherein the at least one sensor captures images during the ablation event.

3. The system of claim 1, wherein the at least one sensor measures temperature associated with the ablation event.

4. (canceled)

5. The system of claim 1, wherein the at least one sensor comprises an optical combiner which receives electromagnetic waves associated with the emitted light from a collimator lens.

6. The system of claim 5, further comprising a spectrometer for characterization of the substrate material and the layer material.

7. The system of claim 6, further comprises a laser-induced breakdown spectroscopy (LIBS) system for characterization of the substrate material.

8. The system of claim 7, further comprising at least one database having reference data for characterization of the substrate material, wherein the reference data is associated with at least one of a plurality of spectra, calibration curves, and the calibration parameters.

9. The system of claim 1, wherein the layer material comprises at least one of paint, lead paint, resin, mold release agent, rust, nuclear contamination, anodized automobile paint

10. The system of claim 1, wherein the substrate material comprises any one of metal, concrete, wood, plastic, composites, fiberglass, and any combination thereof.

11. The system of claim 9, wherein the calibration parameters are associated with settings removal of at least one of the paint, lead paint, resin, mold release agent, rust, nuclear contamination, anodized automobile paint on the substrate material.

12. (canceled)

13. (canceled)

14. The system of claim 1, wherein the calibration parameters pertaining to the characteristics of the laser beam comprise at least one of wavelength, pulse width, output level, frequency, scan speed, power level and shape size.

15. The system of claim 14, comprising a cognitive element capable of self-learning using knowledge gained from previous ablation events to optimize future ablation events.

16. The system of claim 15, whereby the cognitive element automatically changes the calibration parameters on the fly in order to adapt to dynamic conditions associated with the ablation event.

17. The system of claim 1, wherein the laser head is moveable in any one of a x, y and z direction during the ablation event; and wherein the laser head is controlled by at least one of a robotic system and manually.

18. (canceled)

19. A method of laser ablating an area of a substrate material with a layer material to be removed, the method comprising the steps of:
(a) selecting an ablating protocol based on the characteristics of the substrate material and the characteristics of the layer material;
(b) executing, with a processor, at least one first set of program instructions associated with the ablating protocol stored in a computer readable medium to determine calibration parameters for a laser power controller and a laser head;
(c) based on the calibration parameters, generating a laser pulse having a wavelength, pulse width and output level;
(d) transmitting, via an optical fiber, the laser pulse to the laser head having an optical assembly to shape and focus a beam of the laser pulse on the substrate material;
(e) initiating an ablation event by moving the laser head in any one of a x, y and z direction, to cause the laser pulse to impinge the substrate material and the layer material and emit a plasma plume and sound;
(f) capturing at least one of emitted light of the plasma plume and acoustic signals and images, and measuring the temperature associated with the ablation event; receiving, at the processor, the captured at least one of emitted light of the plasma plume, acoustic signals, temperature measurements, and images; and executing, with the processor, at least one second set of program instructions stored in the computer readable medium to determine spectral components of the plasma plume; and
(g) determining, based on at least one of the determined spectral components of the plasma plume, the images, the temperature measurements, and the acoustic signals whether the desired quality requirements for ablating the substrate material are met; when the desired quality requirements are met then continuing the ablation event until the area has been ablated; else dynamically modifying the calibration parameters without user intervention, and proceeding to step (c).

20. (canceled)

21. The method of claim 19, with a cognitive element capable of self-learning, using knowledge gained from previous ablation events to optimize future ablation events, whereby the cognitive element automatically changes the calibration parameters on the fly in order to adapt to dynamic conditions associated with the ablation event; and
wherein the ablating protocol comprises parameters pertaining to the characteristics of the laser beam comprising at least one of pulse width, frequency, scan speed, power level and shape size;
wherein the ablating protocol comprises calibration parameters for removal of at least one of paint, lead paint, resin, mold release agent, rust, nuclear contamination, anodized automobile paint on the substrate material; and
wherein the method comprises a further step of determining a laser damage threshold of the substrate material.

22. (canceled)

23. (canceled)

24. (canceled)

25. (canceled)

26. The method of claim 19, wherein the nuclear contamination on the substrate material comprises at least one of Co-60, Cs-137, Cs-134, and Zn-65.

27. (canceled)

28. (canceled)

29. (canceled)

30. (canceled)

31. (canceled)

32. (canceled)

33. (canceled)

34. The method of claim 19, comprising a step of at least:
recognizing at least one of a shape and a size an object to be ablated;
determining a distance between the laser head and the substrate material based on the acoustic signals, and wherein the measured distance facilitates focusing of the laser beam on the substrate material; and
focusing of laser beam on the substrate material using the captured images of the substrate material and the layer material during the ablating event, thereby enhancing quality assurance.

35. The method of claim 19, wherein the ablation event occurs within an enclosed chamber to contain the plasma plume and gaseous by-products of the ablation event, and wherein a fume extractor is coupled to the enclosed chamber to remove the plasma plume and the gaseous by-products from the enclosed chamber.

36. (canceled)

37. (canceled)

38. A program storage device readable by a computer, tangibly embodying a program of instructions executable by at least one processor to perform a method comprising the steps of:
(a) selecting an ablating protocol for ablating an area of a substrate material with a layer material to be removed, the ablating protocol based on the characteristics of the substrate material and the characteristics of the layer material;
(b) executing, with the at least one processor, at least one first set of program instructions associated with the ablating protocol stored in a computer readable medium to determine calibration parameters for a laser power controller and a laser head;
(c) based on the calibration parameters, generating a laser pulse having a wavelength, pulse width and output level;
(d) transmitting, via an optical fiber, the laser pulse to the laser head having an optical assembly to shape and focus a beam of the laser pulse on the substrate material;
(e) initiating an ablation event by moving the laser head in any one of a x, y and z direction, to cause the laser pulse to impinge the substrate material and the layer material and emit a plasma plume and sound;
(f) capturing at least one of emitted light of the plasma plume and acoustic signals and images, and measuring the temperature associated with the ablation event; receiving, at the at least one processor, the captured at least one of emitted light of the plasma plume, acoustic signals, temperature measurements, and images; and executing, with the at least one processor, at least one second set of program instructions stored in the computer readable medium to determine spectral components of the plasma plume; and
(g) determining, based on at least one of the determined spectral components of the plasma plume, the images, the temperature measurements, and the acoustic signals whether desired quality requirements for ablating the substrate material are met; when the desired quality requirements are met then continuing the ablation event until the area has been ablated; else dynamically modifying the calibration parameters without user intervention, and proceeding to step (c).

39. The program storage device of claim 38, the ablating protocol comprising parameters pertaining to the characteristics of the laser beam comprising at least one of pulse width, frequency, scan speed, power level and shape size; and
wherein the ablating protocol comprising calibration parameters for removal of at least one of paint, lead paint, resin, mold release agent, rust, nuclear contamination, anodized automobile paint on the substrate material.

40. (canceled)

41. (canceled)

42. (canceled)

43. (canceled)

44. (canceled)

45. (canceled)
